(19) United States
(12) Patent Application Publication
(10) Pub. No.: US 2024/0078787 A1
(43) Pub. Date: Mar. 7, 2024

(54) SYSTEMS AND METHODS FOR HYBRID REAL-TIME MULTI-FUSION POINT CLOUD PERCEPTION

(71) Applicants: Ehsan TAGHAVI, Markham (CA); Ryan RAZANI, Toronto (CA); Bingbing LIU, Beijing (CN)

(72) Inventors: Ehsan TAGHAVI, Markham (CA); Ryan RAZANI, Toronto (CA); Bingbing LIU, Beijing (CN)

(21) Appl. No.: 17/902,728

(22) Filed: Sep. 2, 2022

(51) Int. Cl. G06V 10/764; G06T 7/73; G06T 15/20; G06V 10/25; G06V 10/26; G06V 10/74; G06V 10/762; G06V 20/58

(52) U.S. Cl. CPC G06V 10/764; G06T 7/73; G06T 15/205; G06V 10/25; G06V 10/26; G06V 10/74; G06V 10/762; G06V 20/58

(57) ABSTRACT

Method and system for processing a point cloud frame representing a real-world scene that includes one or more objects, including assigning data-element-level classification labels to data elements that each respectively represent one or more points included in the point cloud frame, estimating an approximate position of a first object instance represented in the point cloud frame, assigning an object-instance-level classification label to the first object instance, selecting, for the first object instance, a subgroup of the data elements based on the approximate position, selecting from the subgroup a first cluster of data elements that have assigned data-element-level classification labels that match the object-instance-level classification label assigned to the first object instance, and outputting an object instance list that indicates, for the first object instance, the first cluster of data elements, and the object-instance-level classification label assigned to the first object instance.

### CROSS-REFERENCE TO RELATED APPLICATIONS

This is the first application filed for the present disclosure.

### FIELD

The present application generally relates to object detection, in particular to devices, systems, methods, and media for enhancement of object detection using segmentation and classification to process point cloud data.

### BACKGROUND

Perception is an important task performed by various intelligent/autonomous systems in various fields, such as autonomous driving, autonomous manufacturing, inspection, and medical diagnosis. Intelligent systems such as autonomous vehicles may use one or more Light Detection and Ranging (LiDAR) sensors to perceive their environments. A LiDAR (also referred to a “Lidar” or “LIDAR” herein) sensor generates point cloud data representing a three-dimensional (3D) environment scanned by the LIDAR sensor. A LiDAR sensor generates point cloud data representing a three-dimensional (3D) environment scanned by the LIDAR sensor. Some LIDAR sensors, such as spinning scanning LIDAR sensors, include a laser array that emits light in an arc and the LIDAR sensor rotates around a single location to generate a point cloud frame; other LIDAR sensors, such as solid-state LIDAR sensors, include a laser array that emits light from one or more locations and integrate reflected light detected from each location together to form a point cloud frame. Each laser in the laser array is used to generate multiple point elements per scanning pass, and each point in a point cloud frame corresponds to an object reflecting light emitted by a laser at a point in space in the environment. Each point element (also referred to herein as a “point”) is typically stored as a set of spatial coordinates (X, Y, Z) as well as other data indicating values such as intensity (i.e. the degree of reflectivity of the object reflecting the laser). In a scanning spinning LIDAR sensor, the Z axis of the point cloud frame is typically defined by the axis of rotation of the LIDAR sensor. The Z axis can be roughly orthogonal to an azimuth direction of each laser in most cases (although some LIDAR sensors may angle some of the lasers slightly up or down relative to the plane orthogonal to the axis of rotation).

A single scanning pass of the LIDAR sensor generates an image or “frame” of point cloud data, consisting of a set of points from which light is reflected from one or more points in space, within a time period representing the time it takes the LIDAR sensor to perform one scanning pass. LiDAR can be an effective sensor for perception tasks such as object detection and semantic segmentation because of LiDAR's active sensing nature that provides high resolution sensor readings.

Semantic segmentation refers to the process of partitioning images, or a point cloud frames, obtained from a LiDAR, or alternative visual representation into multiple segments and assigning each segment (for example, each point) a label or tag which is representative of a category that the segment belongs to. Thus, semantic segmentation of a LiDAR point cloud is an attempt to predict the object category (represented as a label or tag that is selected from a set of candidate object categories) for each point of a point cloud frame.

Object detection refers to the process of identifying instances of objects of interest in an image (e.g., in a LiDAR point cloud frame) and generating a label at the instance level for the object of interest. In the context of autonomous driving, object categories (also referred to as classes) can for example include dynamic categories (such as car, truck, pedestrian, cyclist, animal, etc.) and non-dynamic classes (such as road surface, curb, traffic sign, grass, tree, other, etc.).

Most existing approaches for LiDAR semantic segmentation or object detection can be classified into 3 categories: (i) point wise, (ii) spherical front view (SFV) or (iii) bird's eye view (BEV).

Examples of point wise solutions include PointNet (reference [1]: Qi, Charles R., et al. “Pointnet: Deep learning on point sets for 3d classification and segmentation.” Proceedings of the IEEE conference on computer vision and pattern recognition. 2017) and Pointnet++(reference [2]: Charles Ruizhongtai Qi, Li Yi, Hao Su, and Leonidas J Guibas. “Pointnet++: Deep hierarchical feature learning on point sets in a metric space.” In Advances in neural information processing systems, pages 5099-5108, 2017). PointNet and PointNet++ are point wise methods which take lists of points as input, apply input and feature transformations and then aggregate point features by max pooling, and output a list of class labels, one-to-one with the input list by applying a final multi-layer perceptron layer. These point wise methods are usually slow and infeasible to deploy onboard for autonomous driving applications.

Examples of (SFV) solutions include: SqueezeSeg (reference [3]: Wu, Bichen, et al. “Squeezeseg: Convolutional neural nets with recurrent crf for real-time road-object segmentation from 3d lidar point cloud.” 2018 IEEE International Conference on Robotics and Automation (ICRA). IEEE, 2018); SqueezeSegV2 (reference [4]: Wu, Bichen, et al. “Squeezesegv2: Improved model structure and unsupervised domain adaptation for road-object segmentation from a lidar point cloud.” 2019 International Conference on Robotics and Automation (ICRA). IEEE, 2019); and DeepTemporalSeg (reference [5]: Dewan, Ayush, and Wolfram Burgard. “DeepTemporalSeg: Temporally Consistent Semantic Segmentation of 3D LiDAR Scans.” arXiv preprint arXiv:1906.06962 (2019)). SqueezeSeg proposes a CNN-based end-to-end semantic segmentation system which takes in a range-image generated by applying spherical transformation of point cloud, and predicts point-wise label map. A conditional random field (CRF) layer is used in post-processing as a recurrent layer to refine the output. SqueezeSegV2, firstly constructs a SFV image of the point cloud before segmenting it with an encoder/decoder structure using FireModule as element layer and then refines the segments with a recurrent CRF. Although fast and precise, constructing a SFV image introduces quantization error in the input (i.e. not all points make it into the SFV range-image), resulting in a loss of approximately 30% of the points of an original point cloud.

DeepTemporalSeg is an SFV based method that makes temporally consistent semantic segmentations of 3D point clouds. Dense blocks and depth-wise separable convolutions are used in addition to a Bayes filter to recursively estimate the current semantic state of a point in a LiDAR scan. DeepTemporalSeg can suffer information loss due to spherical transformation as is common in SFV approaches.

An example of a BEV solution is SalsaNet (reference [6]: Erdal Aksoy, Eren, Saimir Baci, and Selcuk Cavdar. “SalsaNet: Fast Road and Vehicle Segmentation in LiDAR Point Clouds for Autonomous Driving.” arXiv preprint arXiv:1909.08291 (2019)). SlasaNet uses a BEV constructed image of a point cloud for LiDAR segmentation, with a encoder/decoder structure. Three classes, i.e. ‘Background’, ‘Road’ and ‘Vehicle’ are considered as objects of interest. The LiDAR point clouds are projected into both BEV and SFV processing pipelines. The two pipelines generate similar results with BEV having a better results for ‘Background’ class while SFV having better results for both ‘Road’ and ‘Vehicle’ classes. SalsaNet has a subsequent, upgraded version, SalsaNext (reference [7]: Cortinhal, T., et al. “SalsaNext: Fast Semantic Segmentation of LiDAR Point Clouds for Autonomous Driving.” arXiv preprint arXiv:2003.03653 (2020)).

LiDARSeg (reference [8]: Zhang, Feihu, et al. “Instance segmentation of lidar point clouds.” 2020 International Conference on Robotics and Automation (ICRA). IEEE, 2020) is another method that processes LiDAR point cloud in BEV, however it uses instance segmentation rather than a semantic segmentation. LiDARSeg processes 3D point clouds in BEV, with a K-nearest neighbors (KNN) encoding. It then uses self-attention and voxel features to learn more features. After that, it feeds the high-dimensional BEV into a revised stacked double-hourglass network, including the loss in the middle and at the end.

BEV solutions such as those noted above can have a high degree of complexity, resulting in a network that may be hard to implement and train, require a large amount of storage and operate too slowly to enable effective real-time use.

Accordingly, there is a need for point cloud data perception solution that can effectively and efficiently process point cloud data to enable accurate and computationally efficient real-time usage of such data.

### SUMMARY

The present disclosure describes devices, systems, methods, and media for generating object instance segments for a point cloud by fusing information generated by a semantic segmentation process with information generated an object position approximation process to generate object instance segments. Each object instance segment corresponds to a cluster of points in the point cloud that represent an instance of an object of interest. In some examples, the object instance segments are used to estimate bounding boxes for their respective corresponding objects of interest in an object detection process.

According to a first example aspect, a computer implemented method is disclosed for processing a point cloud frame representing a real-world scene that includes one or more objects. The method includes: assigning respective data-element-level classification labels from a predefined set of candidate classification labels to data elements that each respectively represent one or more points included in the point cloud frame; estimating an approximate position of a first object instance represented in the point cloud frame; assigning an object-instance-level classification label from the predefined set of candidate classification labels to the first object instance; selecting, for the first object instance, a subgroup of the data elements based on the approximate position; selecting, from within the selected subgroup of the data elements, a first cluster of data elements that have assigned data-element-level classification labels that match the object-instance-level classification label assigned to the first object instance; and outputting an object instance list that indicates, for the first object instance, the first cluster of data elements, and the object-instance-level classification label assigned to the first object instance.

According to some examples of the first aspect, selecting the subgroup of the data elements includes determining a region-of-interest relative to the approximate position, the region-of-interest having at least one of a shape and a size that is predefined based on the assigned object-instance-level classification label, wherein the subgroup of the data elements consists of the data elements that are within a boundary defined by the region-of-interest.

According to one or more of the preceding examples of the first aspect, the method includes generating a birds-eye-view (BEV) image corresponding to the point cloud frame, comprising mapping respective sets of one or more points of the point cloud to respective BEV image pixels, wherein estimating the approximate position of the first object instance comprises detecting a representation of the first object instance in the BEV image and determining an approximate position of a center of the representation of the first object instance.

According to one or more of the preceding examples of the first aspect, assigning the object-instance-level classification label to the first object instance is based on the BEV image.

According to one or more of the preceding examples of the first aspect, the method includes: mapping the point cloud frame to a corresponding range image using a surjective mapping process; wherein assigning the respective data-element-level classification labels comprises predicting respective classification labels for pixels of the range image to generate a corresponding segmentation image, and wherein the subgroup of the data elements consists of a subgroup of the pixels of the segmentation image that fall within a boundary of a region-of-interest that is determined based on the approximate position of the first object instance.

According to one or more of the preceding examples of the first aspect, selecting the first cluster of data elements comprises selecting only the pixels within the subgroup of pixels that have classification labels that match the object-instance-level classification label assigned to the first object instance.

According to one or more of the preceding examples of the first aspect, the data elements correspond to respective BEV image pixels of the BEV image.

According to one or more of the preceding examples of the first aspect, the method comprises generating a bounding box and a final classification label for the first object instance based on the object instance list, and generating a vehicle control signal for controlling operation of a vehicle based on the bounding box and final classification label.

According to one or more of the preceding examples of the first aspect, one or more further object instances are represented in the point cloud frame in addition to the first object instance, and the method comprises: estimating an approximate position for each of the one or more of further object instances; assigning a respective object-instance-level classification label from the predefined set of candidate classification labels to each of the one or more of further object instances; for at least some of the one or more of further object instances: selecting a respective subgroup of the data elements based on the approximate position estimated for the further object instance; and selecting, from within the respective selected subgroup of the data elements, a respective cluster of data elements that have assigned data-element-level classification labels that match the object-instance-level classification label assigned to the further object instance, wherein the object instance list also indicates, for the at least some of the one or more further object instances, the cluster of data elements selected therefor, and the object-instance-level classification label assigned thereto.

According to one or more of the preceding examples of the first aspect, predefined set of candidate classification labels are categorized as dynamic object classes and non-dynamic object classes, and the method comprises selecting the respective subgroup of the data elements and selecting the respective cluster of data elements only in respect of the one or more of further object instances that have been assigned an object-instance-level classification label that corresponds to a dynamic object class.

According to one or more of the preceding examples of the first aspect, the point cloud frame is one frame in a sequence of point cloud frames collected in respect of a real-world environment by a Light Detection and Ranging (LiDAR) sensor, the method including for each of a plurality of further point cloud frames included in the sequence: assigning respective data-element-level classification labels from the predefined set of candidate classification labels to further frame data elements that each respectively represent one or more points included in the further point cloud frame; estimating an approximate position of the first object instance as represented in the further point cloud frame; assigning a respective object-instance-level classification label from the predefined set of candidate classification labels to the first object instance; selecting, for the first object instance, a subgroup of the further frame data elements based on the approximate position of the first object instance as represented in the further point cloud frame; selecting, from within the selected subgroup of the further frame data elements, a first cluster of further frame data elements that have assigned data-element-level classification labels that match the object-instance-level classification label assigned to the first object instance; and outputting a further frame object instance list that indicates, for the first object instance, the first cluster of further frame data elements, and the object-instance-level classification label assigned to the first object instance.

In some aspects, the present disclosure describe a system and a non-transitory computer readable medium for implementing one or more of the aspects described above.

### BRIEF DESCRIPTION OF THE DRAWINGS

Reference will now be made, by way of example, to the accompanying drawings which show example embodiments of the present application, and in which:

FIG. 1 is an illustrative example of a point cloud frame showing examples of semantic segmentation and object detection;

FIG. 2 is a block diagram of an example implementation of a semantic segmentation and object detection system, in accordance with examples described herein;

FIG. 3 is a block diagram of a fusion and clustering module of the semantic segmentation and object detection system of FIG. 2;

FIG. 4 graphically illustrates a fusion operation and a clustering operation performed by the fusion and clustering module of FIG. 3;

FIG. 5 is a flow diagram overview of a process performed by the semantic segmentation and object detection system of FIG. 1, according to an example implementation; and

FIG. 6 is a block diagram of an example of an autonomous vehicle with a computing system suitable for implementation of examples described herein.

Similar reference numerals may have been used in different figures to denote similar components.

### DETAILED DESCRIPTION

In one example implementation, the present disclosure describes systems, methods, and computer readable media for fusing segmentation information generated in respect of a point cloud frame with an object position approximation generated in respect of the point cloud frame to generate object instance segments with associated classification labels. Each object instance segment defines a cluster of points in the point cloud frame that corresponds to an instance of an object of interest. In some examples, the object instance segments are used to generate bounding boxes and classification labels for their respective corresponding objects of interest in an object detection process.

In this document, unless the specific context specifies otherwise, the following terms can have the following meanings.

As used herein, “point cloud frame” and “point cloud” can each refer to a “frame” of point cloud data, i.e. an ordered set of reflected points measured by a point cloud sensor such as a LIDAR sensor for a scanning pass. Point cloud frames may also be generated by other scanning technologies, such as high-definition radar or depth cameras, and theoretically any technology using scanning beams of energy, such as electromagnetic or sonic energy, could be used to generate point cloud frames. Whereas examples will be described herein with reference to LIDAR sensors, it will be appreciated that other sensor technologies which generate point cloud frames could be used in some embodiments.

As used herein a “map” can refer to a data structure that includes an ordered set of data elements that each correspond to a respective location in a space that is represented by the map. Each data element can be populated with a value or a vector of values that indicates a characteristic or property of the location that the map element corresponds to. By way of example, a map can be 2D array of data elements that represent a 2D space (e.g. a plane); a map can be a 3D array of data elements that represent a 3D space (e.g., a volume). The data elements can themselves each be made up of mulita-variable vectors such that multi-dimensional data can be embedded in each data element. A point cloud frame is an example of a 3D map in which the data elements correspond to points of the point cloud frame. Camera images, range images and a bird's eye view images are further examples of maps, in which the data elements are commonly referred to as pixels.

As used herein, the term “model” refers to a probabilistic, mathematical, or computational model used to process input data to generate prediction information regarding the input data. In the context of machine learning, a “model” refers to a model trained using machine learning techniques; the term “network” may refer to a model trained using machine learning that is configured as an artificial neural network or other network structure. The term “subnetwork” refers to a portion of network or other model.

As used herein, the terms “module”, “process”, “operation” and “generator” can each refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

As used herein “object of interest” can refer to an object that belongs to an object class that is included in a defined set of possible object classifications.

The following describes example technical solutions of this disclosure with reference to accompanying figures. Similar reference numerals may have been used in different figures to denote similar components.

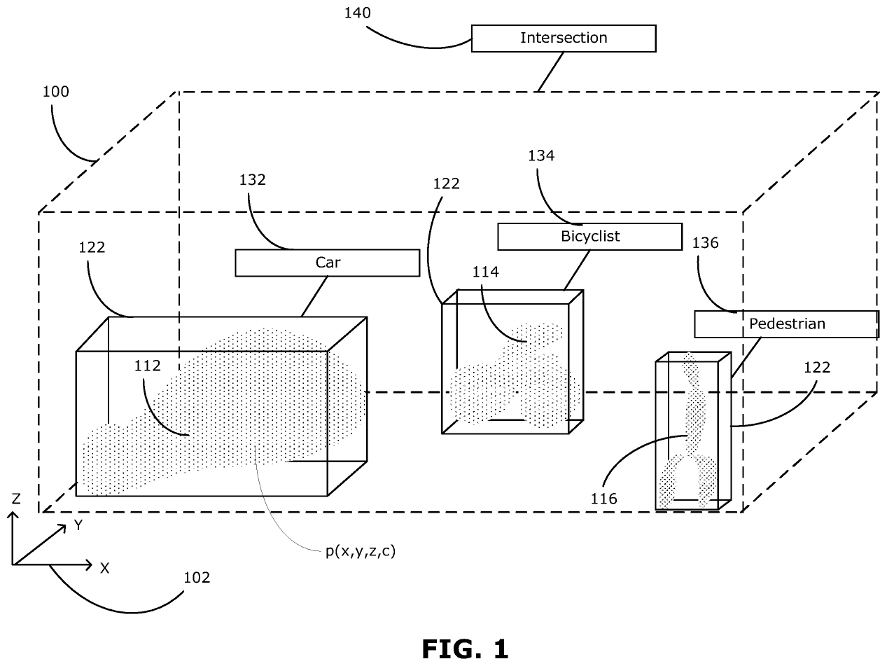

To provide context, FIG. 1 shows an example simplified point cloud frame 100 representation of a real-world scene as captured by a LIDAR sensor. The point cloud frame 100 includes a set of points elements (also referred to as points) mapped to a three-dimensional coordinate system 102 X, Y, and Z, wherein the Z dimension extends upward, typically as defined by the axis of rotation of the LIDAR sensor or other panoramic sensor generating the point cloud frame 100. The point cloud frame 100 that represents a real-world 3D space at a given time (e.g., a scene) as a number of points. Each point p may be represented by a set of coordinates (x, y, z) within the point cloud frame 100 along with a vector of other values, such as an intensity value indicating the reflectivity of an object corresponding to the point. Each point p represents a reflection of light emitted by a laser at a point-in-space relative to the LIDAR sensor corresponding to the point coordinates. Whereas the example point cloud frame 100 is shown as a box-shape or rectangular prism, it will be appreciated that a typical point cloud frame captured by a panoramic LIDAR sensor is typically a 360 degree panoramic view of the environment surrounding the LIDAR sensor, extending out to a full detection range of the LIDAR sensor. The example point cloud frame 100 is thus more typical of a small portion of an actual LIDAR-generated point cloud frame, and is used for illustrative purposes.

The points of the point cloud frame 100 are clustered in space where light emitted by the lasers of the LIDAR sensor are reflected by objects in the environment, thereby resulting in clusters of point elements corresponding to the surface of an object visible to the LIDAR sensor.

As noted above, in the context of point cloud data, sematic segmentation can refer to a task of assigning class labels to individual point elements, and object detection can refer to a task of assigning a bounding box and a class label to an instance of an object of interest. In this regard, FIG. 1 illustrates examples of both (i) point level classification labels corresponding to point-level sematic segmentation, and (ii) object bounding boxes and object instance level classification labels corresponding to object detection.

By way of illustration in point cloud frame 100, a first cluster 112 of points p corresponds to reflections from a dynamic object that is a car. In the example point cloud frame 100, the first cluster 112 of points is enclosed by a bounding box 122 and associated with an object instance-level classification label for the object, in this case the label “car” 132. A second cluster 114 of points 114 is enclosed by a bounding box 122 and associated with the object instance classification label “bicyclist” 134, and a third cluster of points 116 is enclosed by a bounding box 122 and associated with the object instance classification label “pedestrian” 136. Each point cluster 112, 114, 116 thus corresponds to an object instance: an instance of object class “car”, “bicyclist”, and “pedestrian” respectively. The entire point cloud frame 100 is associated with a scene type label 140 “intersection” indicating that the point cloud frame 100 as a whole corresponds to the environment near a road intersection (hence the presence of a car, a pedestrian, and a bicyclist in close proximity to each other).

The object instance classification labels and bounding boxes in FIG. 1 correspond to labels used in the context of object detection. In this regard, the example labelled point cloud frame 100 of FIG. 1 could be included in a training dataset that is used to train a machine learned model for object detection on point cloud frames.

Classification at the point-level (e.g., semantic segmentation) can be used to classify individual point elements that are included in a point cloud frame. An example point element p(x, y, z, c), is illustrated in FIG. 1, where x, y, z is a point location in a reference coordinate system of the point cloud frame 100 and c is a point element classification label). For example, a point cloud frame labeled using semantic segmentation might include multiple “car” object instances that each are represented as a respective point cluster 112, but each point p in each such point cluster would be labeled with the same “car” point-level classification label. Point level semantic segmentation does not distinguish between the individual object instances corresponding to each car in the real-world scene, and does not define the point cloud clusters 112, 114, 116 using bounding boxes. Rather, each point p within each such point cloud cluster would simply be associated with a semantic label indicating a classification category (e.g., “car”, “bicyclist”, “pedestrian”). Semantic segmentation of the point cloud frame 100 can be represented as an X by Y by Z semantic segmentation map, with each point p of the semantic segmentation map representing a respective point p in the feature map and being assigned a respective point element classification label c. The semantic segmentation map can also be represented as set of classification-specific semantic maps, also referred to as masks. For example, a “car” mask can include an X by Y by Z array of elements in which the “car” labelled point elements of the feature map are assigned values of “1” and all other point elements are assigned values of “0”. A “bicyclist” mask can include an X by Y by Z array of point elements in which the “bicyclist” labelled points of the feature map are assigned values of “1” and all other point elements are assigned values of “0”. A set of semantic masks generated in respect of a point cloud frame 100 can include a respective mask for each possible point element class.

In some examples, a single point cloud frame may include multiple scenes, each of which may be associated with a different scene type label 140. A single point cloud frame may therefore be segmented into multiple regions, each region being associated with its own scene type label 140. Example embodiments will be generally described herein with reference to a single point cloud frame being associated with only a single scene type; however, it will be appreciated that some embodiments may consider each region in a point cloud frame separately for point cloud object instance injection using the data augmentation methods and systems described herein.

Known semantic segmentation and object detection solutions for generating the point-level segmentation classification labels and object-instance level bounding boxes and classification labels can be computationally intensive and hence impractical for many real-time applications.

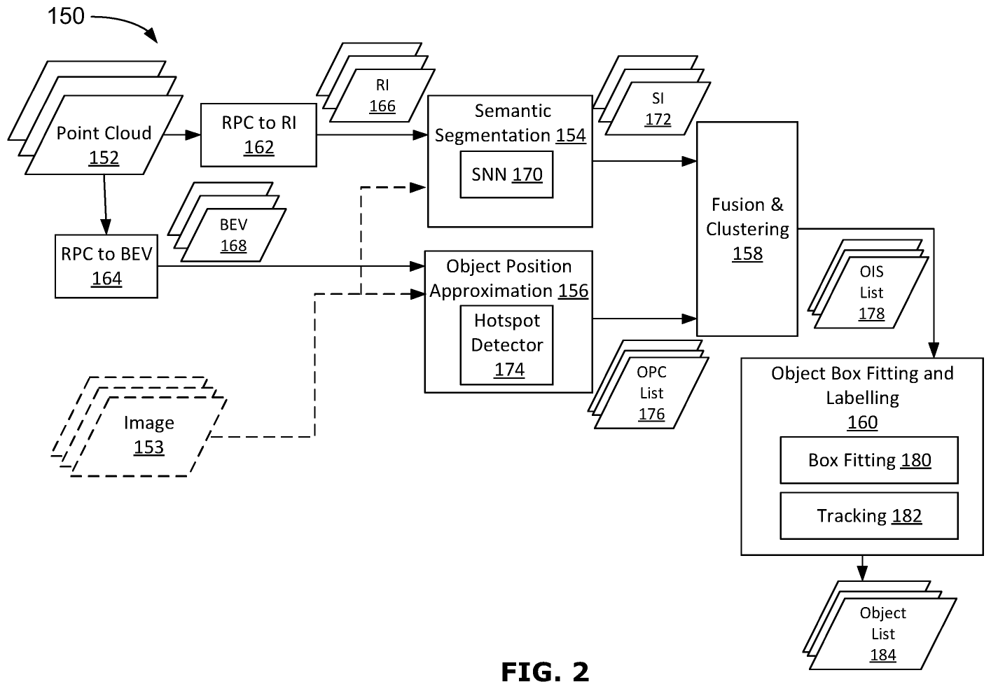

FIG. 2 illustrates a block diagram of a first example implementation of a semantic segmentation and object detection system 150 (“system” 150). The system 150 includes a semantic segmentation module 154, an object position approximation module 156, a fusion and clustering module 158, and an object box fitting and labelling module 160. As will be explained in greater detail below, semantic segmentation module 154 is configured to generate data-element level classification labels for data elements that each represent a respective unique set of one or more the points of an input point cloud frame 152. Object position approximation module 156 is configured to generate object-instance level position approximations and classification labels for objects represented in the input point cloud frame 152. Fusion and clustering module 158 is configured to combine and process the information generated by both semantic segmentation module 154 and object position approximation module 156 to generate an object instance segment (OIS) list 178 that includes respective object instance segments (OISs) for each of the object instances. Each object instance segment defines a cluster of points in the point cloud and a classification label for its respective object instance. The object instance segments generated in respect of an input point cloud frame 152 can be collectively output as an object instance segment list 178. Object box filtering and labelling module 160 processes the object instance segments to estimate bounding boxes and classification labels for the respective corresponding objects of interest of the point cloud frame 152.

In example implementations, known solutions can used to implement operations (described below) that are carried out by the semantic segmentation module 154, object position approximation module 156, and object box fitting and labelling module 160.

In at least some example implementations, the inclusion of fusion and clustering module 158 within the point cloud processing pipeline can enable the use of computational models that require fewer computations and lower storage requirements to perform accurate object detection tasks as compared to known segmentation and object detection solutions. These less complex computational models can, in at least some scenarios, enable a system 150 that requires less storage and less computational power than prior solutions in order to perform accurate real-time computations for real-world autonomous vehicle applications.

In example implementations, the system 150 receives a sequence (e.g., a time series) of raw point cloud frames 152 that are collected in real-time by a LIDAR sensor that is integrated into an autonomous vehicle. In some example implementations, the system 150 may also receive a sequence of real-time video image frames 153 that are collected by one or more light sensing video cameras integrated into the autonomous vehicle.

In the illustrated example, system 150 includes a raw point cloud (RPC) frame to range image (RI) processing module 162 to generate a perspective view range image representation of the scene that is captured by the LIDAR sensor. RPC to RI module 162 is configured to map sampled points from a 3D point cloud frame 152 to corresponding data elements (e.g., pixels) of a range image 166. By way of example, given a point cloud frame 152, a respective range image 166 can be generated by applying a point-to-pixel mapping process that is represented by the following Equation 1:

$$( \begin{matrix}u \\ v\end{matrix} ) = ( \begin{matrix}\frac{1}{2} [ 1 - arc tan ( y , x ) {π}^{- 1} ] W \\ [ 1 - ( arc sin ( {zr}^{- 1} ) + {f}_{up} ) \frac{1}{f} ] H\end{matrix} ) \qquad EQ . 1$$

Where:
The vertical field of the LIDAR sensor is f=fᵤₚ+f_{down};
x, y and z denote the coordinate values of a subject point in the point cloud frame orthogonal (X, Y, Z) coordinate system;
u and v respectively denote the horizontal and vertical coordinate values in the range image coordinate system for the pixel that the subject point maps to;
W and H respectively denote the width and height of the range image in pixels; and
r denotes a range value for the subject point, which can be the Euclidian distance of the subject point to the LIDAR sensor, r=\sqrt{x²+y²+z²}.

Equation 1 represents a surjective mapping process from a point cloud frame 152 to a respective range image 166. In particular, in the example represented by equation 1, not all points in the point cloud frame 152 are included as respective pixels in the range image 166 (e.g., the pixel resolution W×H of range image 166 is lower than the point resolution X×Y×Z of raw point cloud frame 152). Thus, a set of multiple point cloud points can physically map to a single pixel. Accordingly, the set of points that map to a respective pixel is sampled to select a sampled point that is then represented by that pixel. In one example, this sampling is performed by selecting the point in the set of points that is nearest to the LIDAR sensor in Euclidean distance, although other sampling techniques can alternatively be used. A set of attribute values for the sample point are then assigned to the pixel. By way of example, the sample point attributes assigned to the pixel can include the values in the vector [x, y, z, i, r], where x, y, z denote the coordinate values of the sample point in the point cloud frame orthogonal (X, Y, Z) coordinate system; i denotes the measured LIDAR intensity value for the sample point, and rdenotes the sample point's range value.

The use of a smaller number of pixels in a range image 166 relative to the number of points in a point cloud frame 152 (e.g., number of range image data elements=W×H<number of point cloud frame data elements X×Y×Z) can simplify subsequent processing operations by the system 150, thereby enabling computationally efficient real-time semantic segmentation and object detection processing of data relating to a predefined set of multiple classification categories. For example, a large number of classes (e.g., the 28 classes of the sematic-Kitti dataset) can be supported by real-time processing.

Semantic segmentation module 154 is configured to receive the real-time sequence of range images 166 as inputs. For each range image 166, semantic segmentation module 154 generates a respective classification label for each of the pixels thereof (e.g., a classification label for each u,v pixel coordinate). In one example, the range image 166 is provided as a spherical projection to a pre-trained segmentation neural network (SNN) 170 that is configured to assign each range image pixel a respective classification label from a defined set of possible classification labels, resulting in a W by H 2D segmentation image (SI) 172 which each pixel has the attributes: [x, y, z, i, r, class], where class is a point level classification label assigned to the point that is represented by the pixel, and the remaining point level attributes [x, y, z, i, r] are copied from the corresponding pixel of the range image 166. In one illustrative example, the 2D segmentation image 172 can include 64×2048 matrix of pixels, representing a 360 degree view.

It will be noted that the combination of the multi-dimensional vectors [x, y, z, i, r, class] that populate each of the pixels, the sampling of the points, and the mapping provided by Equation 1 embeds 3D information into the 2D data map structure of the segmentation image (SI) 172.

In some examples, semantic segmentation module 154 may also receive the real-time sequence of camera images 153. In such examples, fusion techniques such as early fusion may be used to fuse the data from range images 166 and camera images 153 to form a fused image that is then processed by SNN 170 to produce a corresponding sequence of segmentation images 172.

In the illustrated example, system 150 also includes an RPC frame to birds-eye-view (BEV) image processing module 164 to generate a 2D BEV pixel image representation of the scene that is captured by the LIDAR sensor. RPC to BEV module 164 is configured to map sampled points from a 3D point cloud frame 152 to corresponding pixels of a BEV image 168 by performing a discretized mapping of sets of points of the point cloud frame to respective data elements (e.g., pixels) of the BEV image 168 based on the horizontal plane (x and y) coordinates of the points. In one example, a 3D point cloud frame to 2D BEV image mapping function denoted as G: [symbol] ³→ [symbol] ², where G can be any suitable 3D point cloud frame to 2D BEV image mapping function. In example implementations, a BEV pixel can include information that is fused from a plurality of the points that are included in the set of points that are mapped to the pixel. In some example implementations, a 2D BEV image 168 has the same W and H dimensions and covers the same real-world area represented in the corresponding range image 166 generated in respect of the same point cloud frame 152.

In the illustrated implementation of system 150, object position approximation module 156 processes real-time sequence of BEV images 168 to generate, for each BEV image 168, an object position and classification (OPC) list 176 of approximate positions for object instances that are represented in the BEV image 168 and predicted classification labels for each of the object instances. In some implementations, the approximate position for an object instance, also referred to as a “hotspot”, corresponds to an estimated center of the object in the 2D BEV image coordinate system (which in turn can be mapped by a reverse mapping function G⁻¹ to the point cloud frame coordinate system).

In some examples, the object position approximation module 156 is implemented using a hotspot detector 174 that includes a trained convolutional neural network (CNN) model that is configured to (i) identify unique instances of any objects-of-interest that are represented in BEV image 168; (ii) estimate an approximate position (e.g., a hotspot) for each unique object instance (e.g., the u, v, coordinates of a central pixel of the unique object instance in the 2D BEV coordinate system [symbol] ²); and (iii) predict an preliminary object instance level classification label for each unique object instance. Further, in some examples the object position approximation module 156 may be configured to also generate an estimated orientation of at least some of the object instances (e.g., time series data across multiple images can be used to estimate a direction of travel of a dynamic object instance).

Accordingly, in an example implementation, the OPC list 176 generated in respect of a respective BEV image 168 (which itself corresponds to a respective point cloud frame 152) can include: (i) an estimated center location (e.g.

hotspot) in the 2D BEV coordinate system for each instance of an object of interest represented in the respective BEV image 168/point cloud frame 152, (ii) a preliminary object instance level classification label for each unique object instance, and (iii) an estimated orientation in the 2D BEV coordinate system of the object instance.

In at least some examples, the estimated center location of each unique object instance in the 2D BEV image space can be mapped back into the 3D point cloud space [symbol] ³ using reverse mapping function G⁻¹: [symbol] ²→ [symbol] ³. The 3D point cloud frame coordinates can be included in the OPC list 176.

In some examples, object position approximation module 156 may also receive the real-time sequence of camera images 153. In such examples, fusion techniques such as early fusion may be used to fuse the data from BEV images 168 and camera images 153 to form a fused image that is then processed by hotspot detector 174 to produce a corresponding sequence of OPC lists 176.

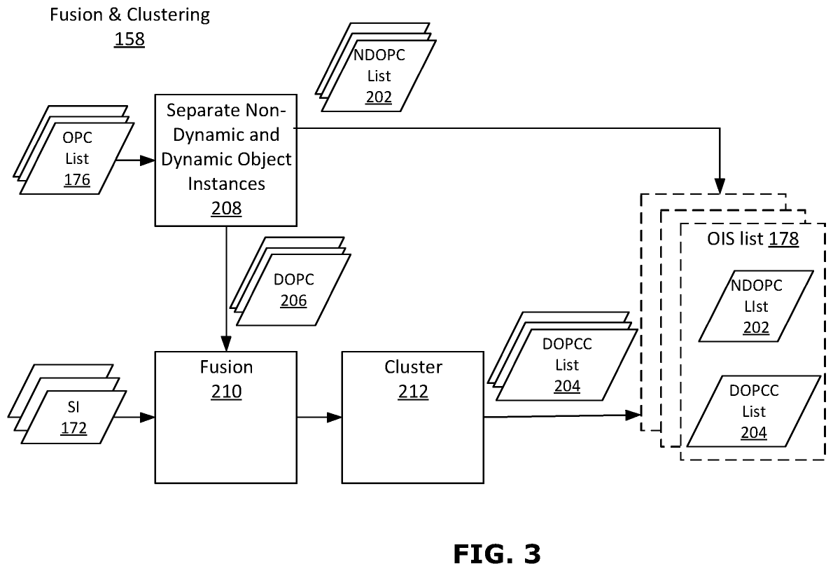

The real-time sequences of segmentation images 172 and OPC lists 176 generated in respect of a sequence of point cloud frames 152 are provided as inputs to fusion and clustering module 158. A block diagram of a possible implementation of fusion and clustering module 158 is illustrated in FIG. 3. Fusion and clustering module 158 processes information from segmentation images 172 and OPC lists 176 to generate a corresponding sequence of object instance segmentation (OIS) lists 178. In at least some example implementations, each OIS list 178 corresponds to a respective point cloud frame 172 and includes: (A) a non-dynamic object position and classification (NDOPC) list 202 of non-dynamic object instances including their respective estimated center location and classification label; and (B) a dynamic object position, classification and cluster (DOPCC) list 204 that identifies, for each dynamic object instance: (i) estimated center location (hotspot), (ii) preliminary classification label and (iii) identification of a cluster of pixels that form the dynamic object instance.

In at least some examples, the fusion and clustering module 158 includes an initial filtering operation 208 to separate the non-dynamic object instances and dynamic object instances that are listed in each OPC list 172. For example, initial filtering operation 208 can be configured to identify, based on the initial object instance level classification label of each of the unique object instances included in an OPC list 172, a first set of the unique object instances that have classification labels that have been pre-defined as corresponding to non-dynamic objects (e.g., roadway, traffic sign, tree, hedge, curb, sidewalk), and a second set of the unique object instances that have classification labels that have been pre-defined as corresponding to dynamic objects (e.g., car, truck, bus, motorcycle, bicycle, pedestrian). The OPC list 172 can be split into two lists for subsequent processing operations, namely a non-dynamic object position and classification (NDOPC) list 202 that includes details of the non-dynamic objects, and a dynamic object position and classification (DOPC) list 206 that include details of the dynamic objects.

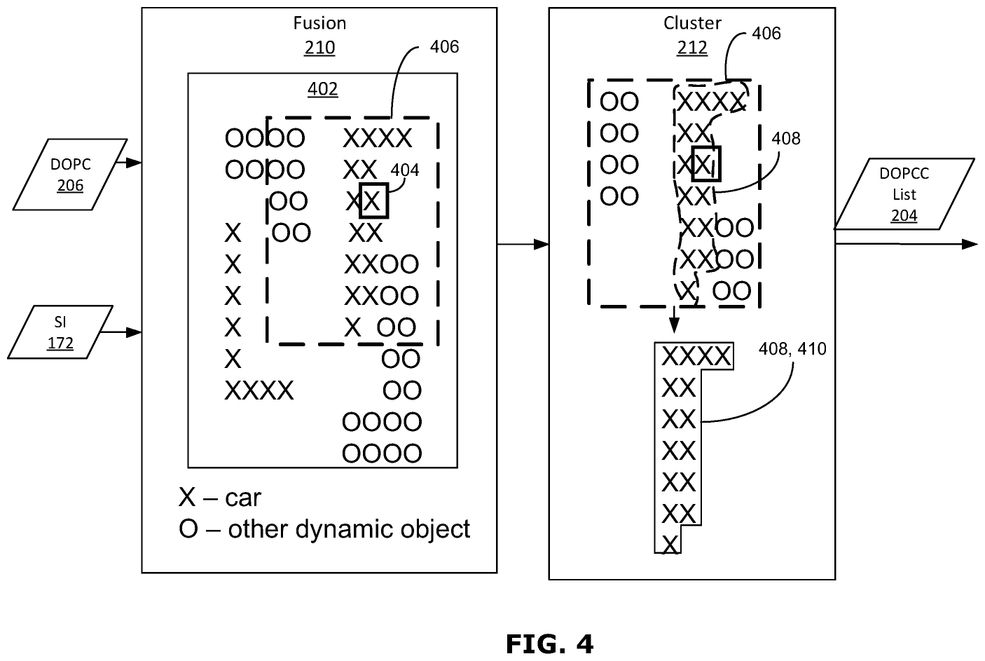

The sequence of dynamic object position and classification (DOPC) lists 206 are provided, along with the sequence of segmentation images 172, to a fusion operation 210 and cluster operation 212 of the fusion and clustering module 158 for further processing. An example of the processing of a single dynamic object instance for a single dynamic object position and classification (DOPC) list 206 and segmentation image 172 (corresponding to a respective point cloud frame 152) is illustrated in FIG. 4. Fusion operation 210 is configured to fuse the data included in the dynamic object position and classification (DOPC) list 206 with the pixel-level semantic segmentation data included in a corresponding segmentation image 172.

In FIG. 4, a 2D BEV space 402 is illustrated that corresponds to a subject BEV image 168 that is represented by the dynamic object position and classification (DOPC) list 206. Fusion operation 210 processes each object instance listed in the dynamic object position and classification (DOPC) list 206 as follows. Fusion operation 210 retrieves the estimated center location (e.g., hotspot position 404) for the object instance that is being processed (also referred to hereafter as the “target object instance”) and preliminary classification label from the dynamic object position and classification (DOPC) list 206. By way of example, the estimated center location (e.g., hotspot position 404) associated with a target object instance labelled with classification label “car” is represented by a solid box in the illustrated 2D BEV space 402. In some implementations, fusion operation 210 assigns a Z-coordinate axis through the hotspot position 404 (i.e., an axis that extends into and out of the page in the context of 2D BEV space 402) for the target object instance in order to align the 2D BEV space 402 with the corresponding 3D point cloud frame space and 2D segmented image space.

Fusion operation 210 then selects a subgroup of the data elements based on the hotspot position 404. In one example implementation, fusion selects the subgroup by first determining a region-of-interest 406 relative to the hotspot position 404. At least one of a size and shape of the region-of-interest 406 is defined based on the preliminary classification label for the object instance represented by hotspot position 404. By way of example, in FIG. 4, the class-based region-of-interest 406 is over-layered on 2D BEV space 402 with hotspot position 404 at its center. In the illustrated example, the size and shape of the region-of-interest 406 correspond to a “car” class. For example, in the case of a car, the size and shape of the region-of-interest 406 may correspond to real-world dimensions of 16 ft by 16 ft. Other dynamic objects may have different pre-defined region-of interest sizes and shapes. In the case of region-of-interest shapes that can have a directional orientation, (for example a non-square rectangular or other polygonal shape), an orientation for the region-of-interest relative to the 2D BEV space 402 and segmentation image space can be assigned based on the estimated orientation in the 2D BEV coordinate system of the target object instance (which as noted above can be specified in the dynamic object position and classification (DOPC) list 206).

Fusion operation 210 maps a boundary defined by the region-of-interest 406 to the segmentation image 172, thereby selecting the subgroup of segmentation image pixels that falls within the region-of-interest 406.

In at least some examples, the classification label associated with the hotspot position 404 in the dynamic object position and classification (DOPC) list 206 is compared with the classification label assigned to the corresponding pixel location in the segmentation image 172 to ensure that the classification labels are the same. An error routine may be triggered if the classification labels do not match.

In summary, fusion operation 210 defines a region-of-interest 406 of the segmentation image 172 that corresponds to the hotspot location of a target object instance. The region-of-interest 406 defines a subset of the pixels of the segmentation image 172. As illustrated in the example of FIG. 4, the region-of-interest 406 encompasses pixels of the segmented image 172 that have been classified with “car” classification labels, and can also include other pixels that have been assigned other dynamic object type classification labels.

Clustering operation 212 is configured to identify, from the subgroup of pixels that fall within region-of-interest 406, a cluster 408 of segmentation image pixels that correspond to the target object instance. By way of example, all of the segmentation image pixels in the region of interest 406 that have the same classification label as the target object are retained as members of the cluster 408 and all segmentation image pixels that have a different classification are excluded from the cluster 408. Accordingly, cluster 408 defines a list of segmentation image pixels from the segmentation image 172 that correspond to the target object such that cluster 408 represents an object-instance level segmentation 410 of the segmentation image 172 corresponding to the target object. The object-instance level segmentation 410 has the same classification level of the target object.

The process illustrated in FIG. 4 can be repeated using class-specific regions of interest 406 and object hotspot position 404 for each of the object-instances included in the dynamic object position and classification (DOPC) list 206 in order to generate the dynamic object position, classification and cluster (DOPCC) list 204 in respect of a point cloud frame 152.

In some example implementations, fusion and clustering operations can also be performed in respect of at least some classes of non-dynamic objects that are included in the non-dynamic object position and classification (NDOPC) list 202 of non-dynamic objects.

As noted above, in example implementations the segmentation image 172 embeds 3D information, including the point cloud coordinate information for the cloud points represented therein and 3D information. Accordingly, in at least some examples, the object-instance level segmentation 410 also embeds the same 3D information, enabling both 2D and 3D based processing to be performed by downstream operations in respect of the OIS lists 178. In particular, the

Referring again to FIG. 2, in example embodiments the sequence of OIS lists 178 generated by fusion and clustering module 158 corresponding to input sequence of point cloud frames 152 can be provided to object box fitting and labelling module 160 that uses the object-instance level information included in the OIS lists 178 to complete an object detection task and output an objects list 184 that includes a set of label classified bounding boxes in respect of each point cloud frame 152. By way of example, object box fitting and labelling module 160 can include a box fitting operation that applies a suitable rules-based algorithm or trained-network model to fit bounding boxes and assign object classification labels to object instances included in a point cloud frame 152 based on the OIS list 178 generated in respect of the frame. In some examples, object box fitting and labelling module 160 can include a tracking operation that applies a suitable rules-based algorithm or trained-network model to associate kinematic data (e.g., direction, speed and/or acceleration) to the object instances included in a point cloud frame 152 based on the OIS lists 178 generated for that point cloud frame and it's preceding and following point cloud frames 152. This kinematic data can be included in the objects list 184.

In the above described implementation of system 150, semantic segmentation module 154 is configured to map a subset of points from an input point cloud frame 152 to a range image 166 that is then subjected to pixel-level semantic segmentation by semantic segmentation module 154. However, in an alternative implementation, the RPC to RI mapping module 162 may be omitted. In such case, instead of rage image 166, the BEV image 168 provided as input to the semantic segmentation module 154 (as well as to the object position approximation module 156). In such examples, the segmented image 172 would be based on the BEV image 168.

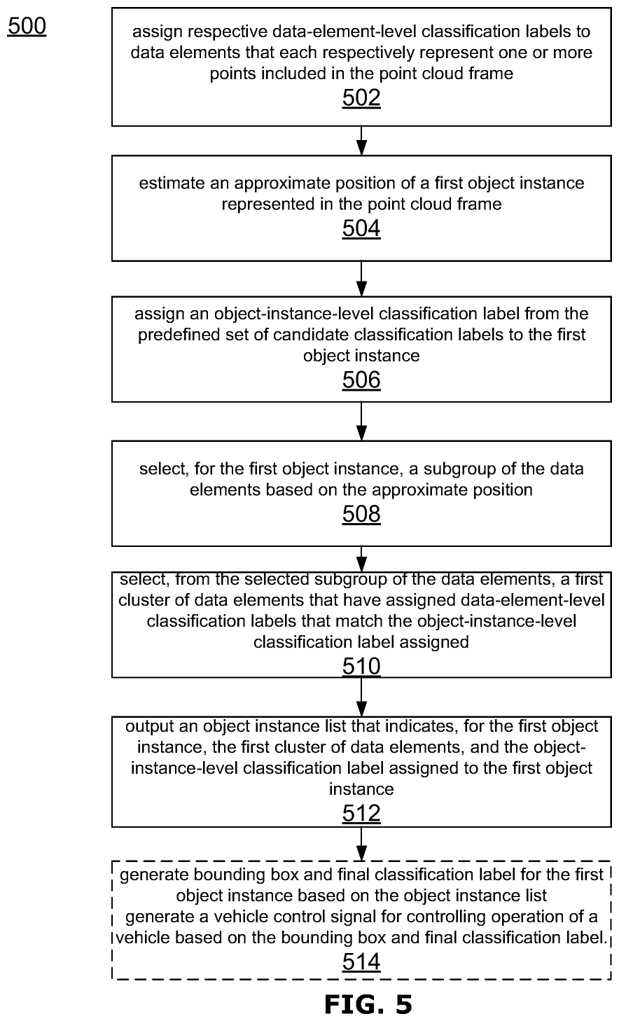

By way of overview, FIG. 5 shows a flow diagram overview of a process 500 performed by the semantic segmentation and object detection system 100 to process an input point cloud frame 152. As indicated at block 502, the process 500 includes assigning respective data-element-level classification labels from a predefined set of candidate classification labels to data elements that each respectively represent one or more points included in the point cloud frame. For example, the data-element-level classification labels can be assigned by semantic segmentation module 154. In some examples, the data elements can be pixels in a range image 166 representation of the point cloud frame 152, and in some alternative examples, the data elements can be pixels in a BEV image 168 representation of the point cloud frame 152.

As indicated at blocks 504 and 506, the process 500 includes estimating an approximate position of a first object instance represented in the point cloud frame and assigning an object-instance-level classification label from the predefined set of candidate classification labels to the first object instance. For example, object position approximation module 156 can be configured to process the BEV image 168 representation of the point cloud frame 152 to detect the first object instance, assign a preliminary classification label to the first object instance, and select the BEV pixel location at the approximate center of the first object instance BEV pixel as the approximate position (e.g., hotspot position 404).

As indicated at block 508, the process 500 includes selecting, for the first object instance, a subgroup of the data elements based on the approximate position. For example, fusion module 210 can select the subgroup of pixels from the pixel segmented range image 166 (or from BEV image 168 in the event that it is used in place of a range image 166) that corresponds to a region-of interest 406 that surrounds the hotspot position 404.

As indicated at block 510, the process 500 includes selecting, from within the selected subgroup of the data elements, a first cluster of data elements that have assigned data-element-level classification labels that match the object-instance-level classification label assigned to the first object instance. For example, clustering module 212 can select pixel cluster 408 from the pixels that are included within the boundary of the region-of-interest 406 based on which pixels are assigned the same classification label as the preliminary classification label that was assigning to the first object instance.

As indicated at block 512, the process 500 includes outputting an object instance list that indicates, for the first object instance, the first cluster of data elements, and the object-instance-level classification label assigned to the first object instance. For example, clustering module 212 can output dynamic object position classification and cluster (DOPCC) list 204, which is incorporated into object instance list 178.

In at least some examples, the region-of-interest 406 has at least one of a shape and a size that is predefined based on the assigned object-instance-level classification label.

As indicated at block 514, in some example implementations, the process 500 includes generating a bounding box and a final classification label for the first object instance based on the object instance list, and generating a vehicle control signal for controlling operation of a vehicle based on the bounding box and final classification label.

In example implementations multiple object instances are represented in the point cloud frame in addition to the first object instance, and the process 500 can be performed in respect of each of the object instances.

In example implementations, the point cloud frame is one frame in a sequence of point cloud frames collected in respect of a real-world environment by a Light Detection and Ranging (LiDAR) sensor, and the process 500 can be performed in respect of each of the point cloud frames.

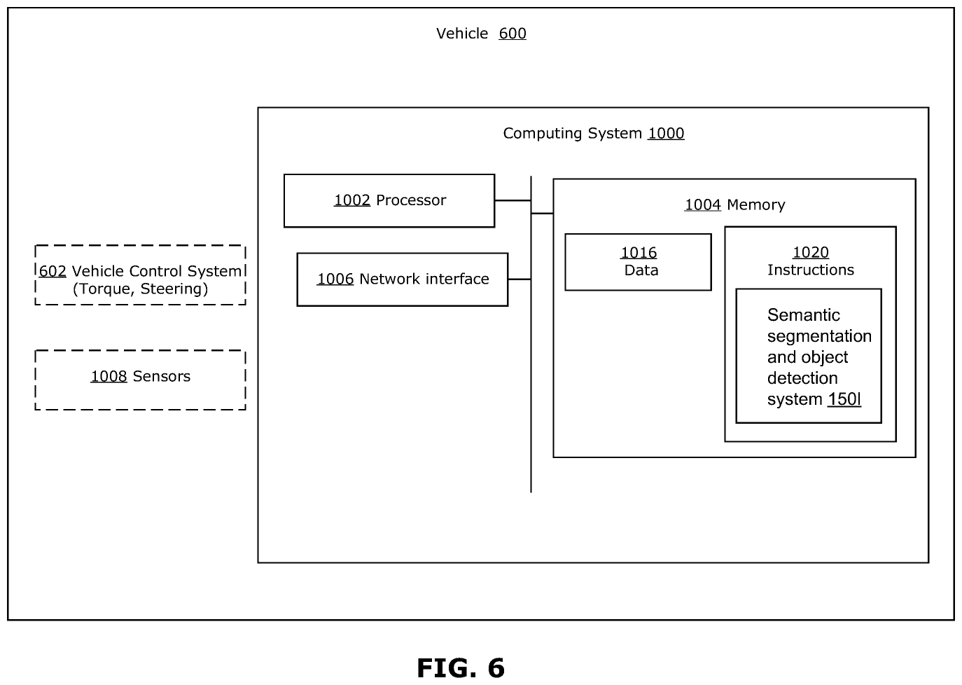

FIG. 6 is a block diagram representing a vehicle 600 to which examples of the semantic segmentation and object detection system 150 disclosed herein can be applied. By way of non-limiting example, the vehicle 600 can be a land-based autonomous or partially autonomous vehicle (for example, a car, truck, bus, utility vehicle, all-terrain vehicle, snow mobile, or industrial robot, among other things). The vehicle 600 includes a computing system 1000 (hereafter system 1000) for providing control instructions to one or more vehicle control systems 602 (e.g., systems that control drive torque, braking, steering, and other functions of the vehicle 600). The vehicle 600 includes one or more sensors 1008 for collecting data about the vehicle 600 and its surrounding environment. Sensors 1008 can include, among other things, one or more LIDAR sensors for generating point cloud frames 152 and one or more video cameras for generating images frames 153.

Although an example embodiment of the system 1000 is shown and discussed below, other embodiments may be used to implement examples disclosed herein, which may include components different from those shown. Although a single instance of each component of the system 1000 is illustrated, there may be multiple instances of each component.

The system 1000 includes one or more processors 1002, such as a central processing unit, a microprocessor, an application-specific integrated circuit (ASIC), a field-programmable gate array (FPGA), a dedicated logic circuitry, a tensor processing unit, a neural processing unit, a tensor processing unit, dedicated artificial intelligence processing unit, an accelerator, or combinations thereof. The one or more processors 1002 may collectively be referred to as a “processor device” or “processor 1002”.

The system 1000 includes one or more memories 1004 (collectively referred to as “memory 1004”), which may include a volatile or non-volatile/non-transitory memory (e.g., a flash memory, a random access memory (RAM), and/or a read-only memory (ROM)). The non-transitory memory 1004 may store machine-executable instructions for execution by the processor 1002, such as to carry out examples described in the present disclosure. A set of machine-executable instructions 1020 for execution by the processor 1002 includes instructions 1501 for implementing semantic segmentation and object detection system 150. The memory 1004 may include other machine-executable instructions, such as for implementing an operating system and other components of an autonomous driving control system, and other applications or functions.

The memory 1004 can store one or more supporting datasets 1016. The memory 1004 may also store other data, information, rules, policies, and machine-executable instructions described herein.

The system 1000 includes at least one network interface 1006 for wired or wireless communication with other systems. For example, the system 1000 may receive sensor data (e.g., LiDAR sensor data) from one or more sensors 1008 via the network interface 1006.

In some examples, the system 1000 may also include one or more electronic storage units (not shown), such as a solid state drive, a hard disk drive, a magnetic disk drive and/or an optical disk drive. In some examples, one or more datasets and/or modules may be provided by an external memory (e.g., an external drive in wired or wireless communication with the system 1000) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 204 to implement data storage, retrieval, and caching functions of the system 200.

The components of the system 1000 may communicate with each other via a bus, for example. In some embodiments, the system 1000 is a distributed computing system such as a cloud computing system and may include multiple computing devices in communication with each other over a network, as well as optionally one or more additional components. The various operations described herein may be performed by different devices of a distributed system in some embodiments.

In example embodiments the object list 184 is used by the computing system to determine control instructions for the vehicle control systems 602 to enable the vehicle to navigate along a planned vehicle path. Such instructions can be provided as signals over the network interface 1006.

### General

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The features and aspects presented in this disclosure may be embodied in many different forms and should not be construed as limited to the embodiments set forth herein. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure. Where possible, any terms expressed in the singular form herein are meant to also include the plural form and vice versa, unless explicitly stated otherwise. In the present disclosure, use of the term “a,” “an”, or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The contents of all published documents identified in this disclosure are incorporated herein by reference.

1. A computer implemented method for processing a point cloud frame representing a real-world scene that includes one or more objects, comprising:
assigning respective data-element-level classification labels from a predefined set of candidate classification labels to data elements that each respectively represent one or more points included in the point cloud frame;
estimating an approximate position of a first object instance represented in the point cloud frame;
assigning an object-instance-level classification label from the predefined set of candidate classification labels to the first object instance;
selecting, for the first object instance, a subgroup of the data elements based on the approximate position;
selecting, from within the selected subgroup of the data elements, a first cluster of data elements that have assigned data-element-level classification labels that match the object-instance-level classification label assigned to the first object instance; and
outputting an object instance list that indicates, for the first object instance, the first cluster of data elements, and the object-instance-level classification label assigned to the first object instance.

2. The method of claim 1 wherein selecting the subgroup of the data elements comprises:
determining a region-of-interest relative to the approximate position, the region-of-interest having at least one of a shape and a size that is predefined based on the assigned object-instance-level classification label, wherein the subgroup of the data elements consists of the data elements that are within a boundary defined by the region-of-interest.

3. The method of claim 1 comprising generating a birds-eye-view (BEV) image corresponding to the point cloud frame, comprising mapping respective sets of one or more points of the point cloud to respective BEV image pixels,
wherein estimating the approximate position of the first object instance comprises detecting a representation of the first object instance in the BEV image and determining an approximate position of a center of the representation of the first object instance.

4. The method of claim 3 wherein assigning the object-instance-level classification label to the first object instance is based on the BEV image.

5. The method of claim 3 comprising:
mapping the point cloud frame to a corresponding range image using a surjective mapping process;
wherein assigning the respective data-element-level classification labels comprises predicting respective classification labels for pixels of the range image to generate a corresponding segmentation image,
wherein the subgroup of the data elements consists of a subgroup of the pixels of the segmentation image that fall within a boundary of a region-of-interest that is determined based on the approximate position of the first object instance.

6. The method of claim 5 wherein selecting the first cluster of data elements comprises selecting only the pixels within the subgroup of pixels that have classification labels that match the object-instance-level classification label assigned to the first object instance.

7. The method of claim 3 wherein the data elements correspond to respective BEV image pixels of the BEV image.

8. The method of claim 1 comprising generating a bounding box and a final classification label for the first object instance based on the object instance list, and generating a vehicle control signal for controlling operation of a vehicle based on the bounding box and final classification label.

9. The method of claim 1 wherein one or more further object instances are represented in the point cloud frame in addition to the first object instance, the method comprising:
estimating an approximate position for each of the one or more of further object instances;
assigning a respective object-instance-level classification label from the predefined set of candidate classification labels to each of the one or more of further object instances;
for at least some of the one or more of further object instances:
selecting a respective subgroup of the data elements based on the approximate position estimated for the further object instance; and
selecting, from within the respective selected subgroup of the data elements, a respective cluster of data elements that have assigned data-element-level classification labels that match the object-instance-level classification label assigned to the further object instance,
wherein the object instance list also indicates, for the at least some of the one or more further object instances, the cluster of data elements selected therefor, and the object-instance-level classification label assigned thereto.

10. The method of claim 9 wherein predefined set of candidate classification labels are categorized as dynamic object classes and non-dynamic object classes, wherein the method comprises selecting the respective subgroup of the data elements and selecting the respective cluster of data elements only in respect of the one or more of further object instances that have been assigned an object-instance-level classification label that corresponds to a dynamic object class.

11. The method of claim 1 wherein the point cloud frame is one frame in a sequence of point cloud frames collected in respect of a real-world environment by a Light Detection and Ranging (LiDAR) sensor, the method comprising for each of a plurality of further point cloud frames included in the sequence:
assigning respective data-element-level classification labels from the predefined set of candidate classification labels to further frame data elements that each respectively represent one or more points included in the further point cloud frame;
estimating an approximate position of the first object instance as represented in the further point cloud frame;
assigning a respective object-instance-level classification label from the predefined set of candidate classification labels to the first object instance;
selecting, for the first object instance, a subgroup of the further frame data elements based on the approximate position of the first object instance as represented in the further point cloud frame;
selecting, from within the selected subgroup of the further frame data elements, a first cluster of further frame data elements that have assigned data-element-level classification labels that match the object-instance-level classification label assigned to the first object instance; and
outputting a further frame object instance list that indicates, for the first object instance, the first cluster of further frame data elements, and the object-instance-level classification label assigned to the first object instance.

12. A system comprising:
a processor device;
a point cloud sensor coupled to the processor device and configured to generate a point cloud frame representation of a real-world scene that includes one or more objects;
a non-transient memory coupled to the processor device, the memory storing executable instructions that when executed by the processor device configure the system to perform a task comprising:
assigning respective data-element-level classification labels from a predefined set of candidate classification labels to data elements that each respectively represent one or more points included in the point cloud frame;
estimating an approximate position of a first object instance represented in the point cloud frame;
assigning an object-instance-level classification label from the predefined set of candidate classification labels to the first object instance;
selecting, for the first object instance, a subgroup of the data elements based on the approximate position;
selecting, from within the selected subgroup of the data elements, a first cluster of data elements that have assigned data-element-level classification labels that match the object-instance-level classification label assigned to the first object instance; and
outputting an object instance list that indicates, for the first object instance, the first cluster of data elements, and the object-instance-level classification label assigned to the first object instance.

13. The system of claim 12 wherein selecting the subgroup of the data elements comprises:
determining a region-of-interest relative to the approximate position, the region-of-interest having at least one of a shape and a size that is predefined based on the assigned object-instance-level classification label, wherein the subgroup of the data elements consists of the data elements that are within a boundary defined by the region-of-interest.

14. The system of claim 12, the task comprising generating a birds-eye-view (BEV) image corresponding to the point cloud frame, comprising mapping respective sets of one or more points of the point cloud to respective BEV image pixels,
wherein estimating the approximate position of the first object instance comprises detecting a representation of the first object instance in the BEV image and determining an approximate position of a center of the representation of the first object instance; and
wherein assigning the object-instance-level classification label to the first object instance is based on the BEV image.

15. The system of claim 14 wherein the task comprises mapping the point cloud frame to a corresponding range image using a surjective mapping process;
wherein assigning the respective data-element-level classification labels comprises predicting respective classification labels for pixels of the range image to generate a corresponding segmentation image, and
wherein the subgroup of the data elements consists of a subgroup of the pixels of the segmentation image that fall within a boundary of a region-of-interest that is determined based on the approximate position of the first object instance.

16. The system of claim 15 wherein selecting the first cluster of data elements comprises selecting only the pixels within the subgroup of pixels that have classification labels that match the object-instance-level classification label assigned to the first object instance.

17. The system of claim 14 wherein the data elements correspond to respective BEV image pixels of the BEV image.

18. The system of claim 12, the task comprising generating a bounding box and a final classification label for the first object instance based on the object instance list, and generating a vehicle control signal for controlling operation of a vehicle based on the bounding box and final classification label.

19. The system of claim 12 wherein one or more further object instances are represented in the point cloud frame in addition to the first object instance, the task comprising:
estimating an approximate position for each of the one or more of further object instances;
assigning a respective object-instance-level classification label from the predefined set of candidate classification labels to each of the one or more of further object instances;
for at least some of the one or more of further object instances:
selecting a respective subgroup of the data elements based on the approximate position estimated for the further object instance; and
selecting, from within the respective selected subgroup of the data elements, a respective cluster of data elements that have assigned data-element-level classification labels that match the object-instance-level classification label assigned to the further object instance,
wherein the object instance list also indicates, for the at least some of the one or more further object instances, the cluster of data elements selected therefor, and the object-instance-level classification label assigned thereto.

20. A non-transitory computer readable medium having instructions stored thereon, wherein the instructions, when executed by a processor device of a computing system, cause the computing system to perform a method comprising:
assigning respective data-element-level classification labels from a predefined set of candidate classification labels to data elements that each respectively represent one or more points included in a point cloud frame;
estimating an approximate position of a first object instance represented in the point cloud frame;
assigning an object-instance-level classification label from the predefined set of candidate classification labels to the first object instance;
selecting, for the first object instance, a subgroup of the data elements based on the approximate position;
selecting, from within the selected subgroup of the data elements, a first cluster of data elements that have assigned data-element-level classification labels that match the object-instance-level classification label assigned to the first object instance; and
outputting an object instance list that indicates, for the first object instance, the first cluster of data elements, and the object-instance-level classification label assigned to the first object instance.
